(19) United States
(12) Patent Application Publication
(10) Pub. No.: US 2014/0047246 A1
(43) Pub. Date: Feb. 13, 2014

(54) FLASH MEMORY DEVICE INCLUDING KEY CONTROL LOGIC AND ENCRYPTION KEY STORING METHOD

(71) Applicant: SAMSUNG ELECTRONICS CO., LTD., Suwon-si (KR)

(72) Inventors: CHANGKYU SEOL, OSAN-SI (KR); JUNJIN KONG, YONGIN-SI (KR); HONG RAK SON, ANYANG-SI (KR)

(21) Appl. No.: 13/957,652

(22) Filed: Aug. 2, 2013

(30) Foreign Application Priority Data
Aug. 7, 2012 (KR) 10-2012-0086444

(51) Int. Cl. G06F 21/79

(52) U.S. Cl. CPC G06F 21/79
USPC 713/193

(57) ABSTRACT

A flash memory device is provided which includes a plurality of memory cells connected with a word line and including a key cell to store an encryption key; a data input/output circuit configured to receive the encryption key; and key control logic configured to control a program operation on the key cell and to use a column address of the key cell as the encryption key.

### CROSS-REFERENCE TO RELATED APPLICATIONS

A claim for priority under 35 U.S.C. §119 is made to Korean Patent Application No. 10-2012-0086444 filed Aug. 7, 2012, the subject matter of which is hereby incorporated by reference.

### BACKGROUND

Embodiments of the inventive concept relate to semiconductor memory devices, and more particularly, flash memory devices including key control logic. Embodiments of the inventive concept also relate to encryption key storing methods for use with semiconductor memory devices.

Semiconductor memories may be classified as volatile (e.g., DRAM, SRAM, etc.) and non-volatile (EEPROM, FRAM, PRAM, MRAM, flash memory, etc.) according their operative nature. While volatile memories lose stored data in the absence of applied power, non-volatile memories are able to retain stored data in the absence of applied power.

Among other types of non-volatile memories, flash memory has particular merits including relatively fast read operations, low power consumption, and high density data storage. As a result, flash memory has been widely adopted for use as a data storage medium within memory systems of contemporary computer systems, consumer electronics, and handheld devices.

Increasingly prolific threats to and attacks on stored data necessitate the encryption of stored data, including the data stored in memory systems implemented with the flash memory. As will be appreciated by those skilled in the art, data may be encrypted using a so-called “encryption key”. An encryption key may be generated using one or more data values derived from (e.g.,) user-provided information, a given code value, a random number, or a combination of such data values.

In certain applications, one or more encryption key(s) must be stored in flash memory with corresponding encrypted data. This co-location of stored data and encryption key(s) creates a data security threat as flash memory may be readily read, unless additional measures are taken to protect the stored encryption key(s).

### SUMMARY

Certain embodiments of the inventive concept provide a flash memory device comprising; a plurality of memory cells including a key cell, each respectively connected to a word line, a data input/output (I/O) circuit configured to receive the encryption key, and key control logic configured to control a program operation directed to the key cell, wherein the program operation uses a column address of the key cell as the encryption key.

Certain embodiments of the inventive concept provide an encryption key storing method, comprising; receiving an encryption key via a data input/output (I/O) circuit, dividing the encryption key by a column address bit unit, determining a key cell corresponding to a column address for each one of a plurality of word lines using a value equal to a size of the encryption key divided by the column address bit unit, and then, programming the key cell according to a key cell threshold voltage distribution.

Certain embodiments of the inventive concept provide a method of operating a flash memory storing an encryption key, the flash memory including a flash memory cell array having a plurality of multi-level flash memory cells, the method comprising; generating encrypted data using the encryption key and storing the encrypted data in the flash memory cell array according to one of: an erase data state (E) indicated by an erased threshold voltage distribution (EThVD), a first programmed data state (P1) indicated by a first programmed threshold voltage distribution (P1ThVD) higher than the EThVD, a second programmed data state (P2) indicated by a second programmed threshold voltage distribution (P2ThVD) higher than the P1ThVD, and a third programmed data state (P3) indicated by a third programmed threshold voltage distribution (P3ThVD) higher than the P2ThVD, determining key cells among the plurality of flash memory cells, and during a program operation, programming each one of the key cells according to a key cell threshold voltage distribution (KCThVD) higher than the P3ThVD.

### BRIEF DESCRIPTION OF THE DRAWINGS

The above and other objects and features of the inventive concept will become more readily apparent upon consideration of certain embodiments illustrated in the accompanying drawings.

FIG. 1 is a block diagram illustrating a memory system according to an embodiment of the inventive concept.

FIG. 2 is a block diagram illustrating a flash memory system according to an embodiment of the inventive concept.

FIG. 3 is a block diagram further illustrating the flash memory of FIG. 2.

FIG. 4 is a flowchart summarizing one possible method of operating the key control logic of FIG. 3.

FIGS. 5, 6, 7, and 8 are respective conceptual diagrams further illustrating the method of FIG. 4.

FIG. 9 is a diagram illustrating one possible method of programming a key cell corresponding to a decided column address.

FIG. 10 is a conceptual diagram further illustrating one possible method of reading an encryption key stored in flash memory cells.

FIG. 11 is a general block diagram illustrating a flash memory system according to an embodiment of the inventive concept.

FIG. 12 is a block diagram illustrating a memory card system that may incorporate a memory system according to an embodiment of the inventive concept.

FIG. 13 is a block diagram illustrating a solid state drive (SSD) system that may incorporate a memory system according to the inventive concept.

FIG. 14 is a block diagram further illustrating the SSD controller of FIG. 13.

FIG. 15 is a general block diagram illustrating an electronic device that may incorporate a flash memory system according to an embodiment of the inventive concept.

FIG. 16 is a general block diagram illustrating a flash memory having a three-dimensional (3D) memory cell array consistent with certain embodiments of the inventive concept.

FIG. 17 is a perspective view illustrating one possible 3D structure of a memory block in the flash memory array of FIG. 16.

FIG. 18 is an equivalent circuit diagram further illustrating the memory block of FIG. 17.

### DETAILED DESCRIPTION

Embodiments of the inventive concept will now be described in some additional detail with reference to the accompanying drawings. The inventive concept, however, may be embodied in various different forms, and should not be construed as being limited to only the illustrated embodiments. Rather, the illustrated embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description. The size(s) and relative size(s) of layers and regions may be exaggerated in the drawings for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

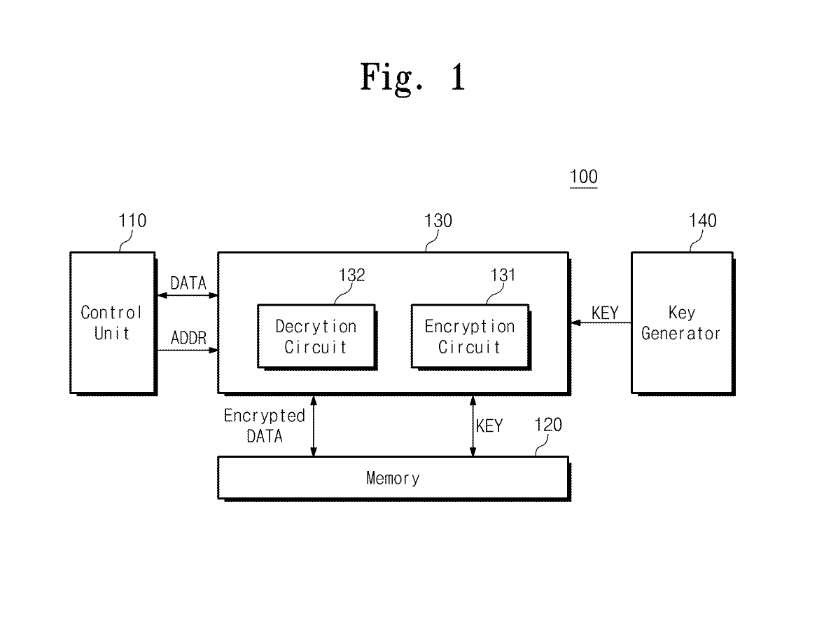

FIG. (FIG.) 1 is a block diagram illustrating a memory system according to an embodiment of the inventive concept. Referring to FIG. 1, a memory system 100 comprises a control unit 110, a memory 120, a security circuit 130, and a key generator 140.

As with all memory systems, an embodiment of the inventive concept may suffer external attacks such as probing, fault injection, power analysis, and the like. To protect data against the external attacks, the memory system 100 may encrypt data to be stored using one or more many conventionally understood encryption techniques to generate “encrypted data”. The encrypted data may then be stored in the memory 120.

Referring to FIG. 1, the control unit 110 may be used to control the overall operation of the memory system 100 including data communication, data processing, and/or computational operations. The memory 120 may be variously used to store application and/or operating system programs to be executed by the control unit 110. The memory 120 may also or alternately be used to store user-provided data (hereafter, “user data”). In certain embodiments, the memory 120 may include at least one nonvolatile memory such as a random access memory, a read only memory, a flash memory, or the like. Memory 120 is illustrated in FIG. 1 as a single operational block, but those skilled in the art recognize that memory 120 may be variously implemented using one or more memory devices, modules and/or chips. of various types. Indeed, memory 120 may also include one or more volatile memories serving, for example, as a data buffer or cache.

The security circuit 130 of FIG. 1 includes an encryption circuit 131 and a decryption circuit 132. The encryption circuit 131 may receive an address (ADDR) and a key during a write operation to encrypt incoming data. In the example of FIG. 1, the address and corresponding incoming data are provided by the control unit 110, while the key is provided by the key generator 140. The decryption circuit 132 may subsequently receive the address and key in order to decrypt encrypted data retrieved during a read operation.

Certain conventional memory systems use a separate data storage medium from (e.g.,) memory 120 to store an encryption key. However, this approach drives up the cost and size of the overall memory system. In contrast, when an encryption key is stored in a general memory (e.g., memory 120 or the same physical data storage medium used to store user data and/or programming code) according to an embodiment of the inventive concept, the overall size and complexity of the memory space may be reduced. Yet, as will be seen hereafter, the encryption key may be safely stored—despite being co-located in a data storage medium (e.g., flash memory) with encrypted data.

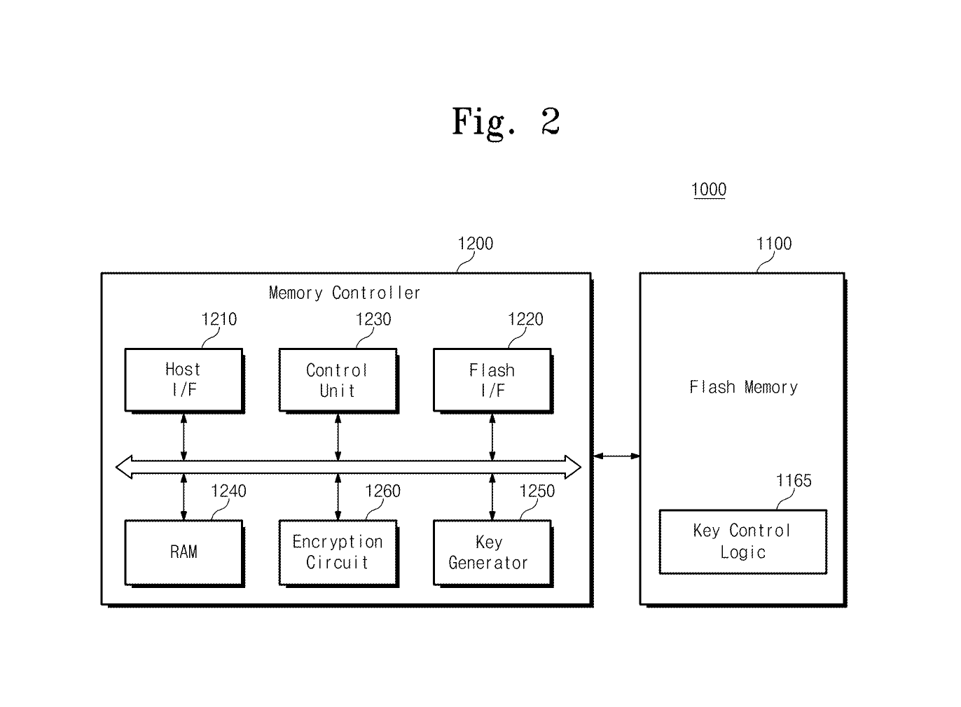

FIG. 2 is a block diagram illustrating a flash memory system according to an embodiment of the inventive concept. Referring to FIG. 2, a flash memory system 1000 generally comprises a flash memory 1100 and a memory controller 1200. The flash memory system 1000 may include flash memory based data storage devices such as a memory card, an USB memory, a solid state drive (SSD), and the like.

The flash memory 1100 may perform an erase, write, or read operation under the control of the memory controller 1200. The memory controller 1200 may control read and write operations on the flash memory 1100 in response to a request of an external device (e.g., a host). Referring to FIG. 2, the memory controller 1200 may include a host interface 1210, a flash interface 1220, a control unit 1230, a RAM 1240, a key generator 1250, and an encryption circuit 1260.

The host interface 1210 may interface with the external device (e.g., the host), and the flash interface 1220 may interface with the flash memory 1100. The host interface 1210 may be connected with the host via a parallel ATA bus, a serial ATA bus, an SCSI, an USB, and the like.

The control unit 1230 may control an overall operation of the flash memory 1100 including reading, writing, file system managing, and the like. For example, although not shown in FIG. 2, the control unit 1230 may include a CPU, a processor, an SRAM, a DMA controller, and the like.

The RAM 1240 may operate responsive to the control of the control logic 1230, and may be used as a work memory, a buffer memory, a cache memory, and the like. When used as the work memory, data processed by the control unit 1230 may be temporarily stored at the RAM 1240. When used as the buffer memory, the RAM 1240 may be used to buffer data to be transferred from the flash memory 1100 to the host or from the host to the flash memory 1100. When used as the cache memory, the RAM 1240 may enable the low-speed flash memory 1100 to operate in high speed.

The RAM 1240 may be used as a drive memory to drive a flash translation layer FTL. The FTL may be used to manage a merge operation, a mapping table, and the like associated with the flash memory 1100.

The key generator 1250 may generate an encryption key using user information or a random number. The encryption circuit 1260 may receive a key from the key generator 1250 to encrypt data. The encrypted data and the encryption key may be stored at the flash memory 1100.

The flash memory 1100 may include key control logic 1165. The key control logic 1165 may perform an operation where an encryption key provided from the memory controller 1200 is stored at the flash memory 1100. The flash memory 1100 including the key control logic 1165 will be more fully described later.

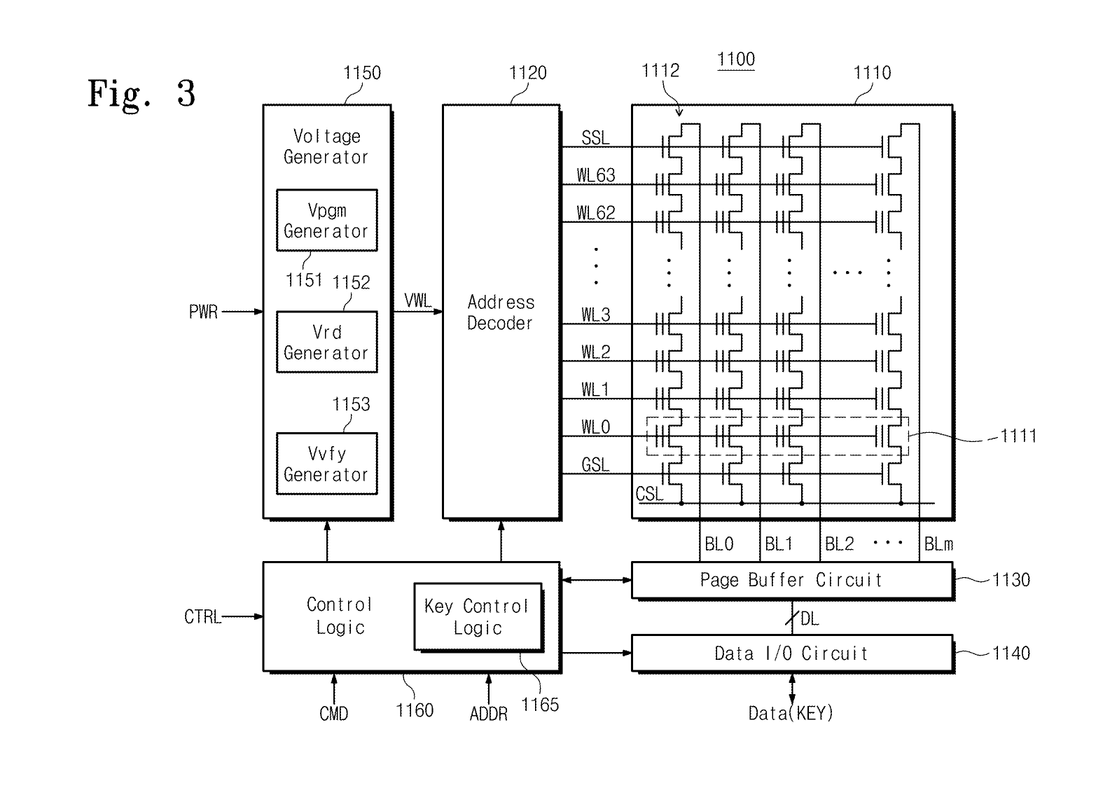

FIG. 3 is a block diagram further illustrating the flash memory of FIG. 2. Referring to FIG. 3, a flash memory 1100 comprises a memory cell array 1110, an address decoder 1120, a page buffer circuit 1130, a data input/output (I/O) circuit 1140, a voltage generator 1150, and control logic 1160.

The memory cell array 1110 may be formed of a plurality of memory blocks. As an example, one memory block is illustrated in FIG. 3. Each memory block may be formed of a plurality of physical pages. Herein, the physical page may mean a set of memory cells connected with a word line. In FIG. 3, a reference numeral “1111” may indicate a physical page. Each physical page may be formed of a plurality of memory cells. Each memory cell may be formed of a cell transistor having a control gate and a floating gate.

The memory cell array 1110 may include a plurality of cell strings 1112. Each cell string 1112 may include a string selection transistor connected with a string selection line SSL, a plurality of memory cells each connected with a plurality of word lines WL0 to WL63, and a ground selection transistor connected with a ground selection line GSL. In each cell string 1112, the string selection transistor may be connected with a corresponding bit line, and the ground selection transistor may be connected with a common source line CSL.

In the flash memory 1100, one memory cell may store a single bit of data or two or more bits of data (hereinafter, referred to as multi-bit data). An SLC flash memory storing 1-bit data per memory cell may have one of an erase state and a program state according to a threshold voltage distribution. An MLC flash memory storing multi-bit data per memory cell may have one of an erase state and plural program states according to a threshold voltage distribution.

The address decoder 1120 may be connected to the memory cell array 1110 via the selection lines SSL and GSL or the word lines WL0 to WL63. The address decoder 1120 may select a word line (e.g., WL0) in response to an address ADDR.

The page buffer circuit 1130 may be connected to the memory cell array 1110 via bit lines BL0 to BLm. The page buffer circuit 1130 may include a plurality of page buffers (not shown). A page buffer may be connected to a bit line, which is referred to as the all bit line structure. Two or more page buffers may be connected to a bit line, which is referred to as the shield bit line structure. The page buffer circuit 1130 may temporarily store data to be programmed or data read out from the selected page 1111.

The data I/O circuit 1140 may be connected to the page buffer circuit 1130 via data lines DL. Further, the data I/O circuit 1140 may be connected to a memory controller 1200 (refer to FIG. 2) via I/O lines. The data input/output circuit 1140 may receive program data from the memory controller 1200 at programming and provide read data to the memory controller 1200 at reading.

The data I/O circuit 1140 may receive an encryption key together with encrypted data. The data I/O circuit 1140 may provide the encrypted data to the page buffer circuit 1130 and the encryption key to the control logic 1160. The encryption key may be provided to key control logic 1165 in the control logic 1160.

The voltage generator 1150 may receive a power PWR from the memory controller 1200 to generate a word line voltage VWL needed to read or write data. The word line voltage VWL may be provided to the address decoder 1120. As illustrated in FIG. 3, the voltage generator 1150 may include a program voltage generator 1151, a read voltage generator 1152, and a verify voltage generator 1153.

The program voltage generator 1151 may generate a program read voltage to be transferred to a selected word line at a program operation. The read voltage generator 1152 may generate a read voltage to be transferred to a selected word line at a read operation. The verify voltage generator 1153 may generate a verify voltage to be transferred to a selected word line at a program verify operation. The program verify operation may be an operation for checking whether a threshold voltage of a memory cell reaches the verify voltage, after programming on a selected word line is executed.

The control logic 1160 may control programming, reading, and erasing of the flash memory 1100 using a command CMD, an address ADDR, and a control signal CTRL. For example, at reading, the control logic 1160 may control the address decoder 1120 to provide the read voltage to a selected word line and the page buffer circuit 1130 and the data I/O circuit 1140 to read program data of a selected page.

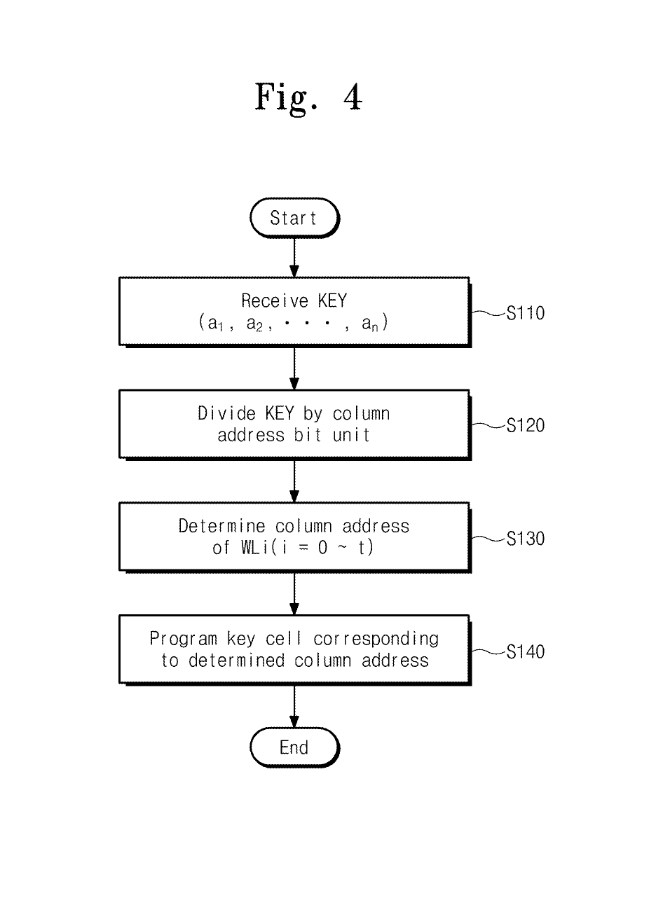

The control logic 1160 may include the key control logic 1165. The key control logic 1165 may receive an encryption key from the memory controller 1200 via the data I/O circuit 1140. The key control logic 1165 may receive the encryption key to perform an encryption key storing operation according to an embodiment of the inventive concept. This will be described in some additional detail with reference to FIG. 4.

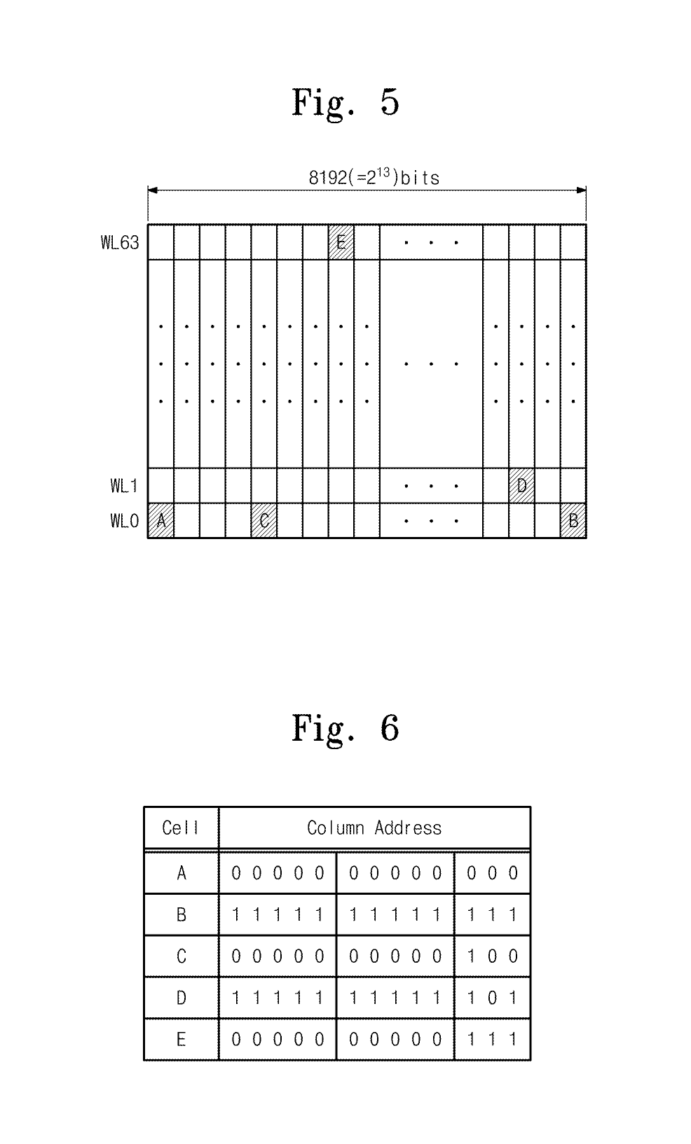

FIG. 4 is a flowchart summarizing one possible method of operating the key control logic of FIG. 3. FIGS. 5, 6, 7 and 8 are respective conceptual diagrams further illustrating the method of FIG. 4. Hereafter, an exemplary encryption key storing method according to an embodiment of the inventive concept will be described with collective reference to FIGS. 4, 5, 6, 7 and 8.

For ease of description, it is assumed that a memory cell array 1110 of FIG. 3 is connected with 64 word lines WL0 to WL63 and 8192 bit lines BL0 to BL8191 as illustrated in FIG. 5. In this case, a page buffer circuit 1130 (refer to FIG. 3) may include 8192 (=2¹³) page buffers, and the memory cell array 1110 may include (2⁸×2¹³) memory cells.

8192 memory cells connected with a word line (e.g., WL0) may be distinguished by a 13-bit column address. For example, a memory cell A connected with WL0 may be expressed by [00000 00000 000], and a memory cell B connected with WL0 may be expressed by [11111 11111 111]. FIG. 6 shows column addresses corresponding to memory cells A to E of FIG. 5. Referring to FIGS. 5 and 6, a memory cell C connected with WL0 may correspond to a column address [00000 00000 100], a memory cell D connected with WL1 may correspond to a column address [11111 11111 101], and a memory cell E connected with WL63 may correspond to a column address [00000 00000 111].

With this set of working assumptions in place, the method of FIG. 4 begins when key control logic 1165 receive an n-bit encryption key (S110)—e.g., an encryption key having the simple integer format of (a1, a2, . . . , an). As described above, like normal incoming data, an encryption key may be provided by the memory controller 1200 to the key control logic 1165 via data I/O circuit 1140.

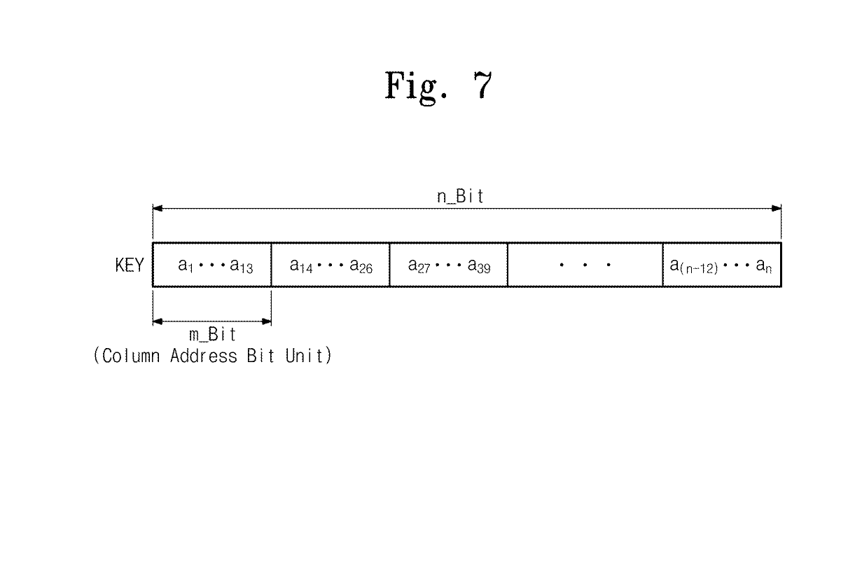

Next, the key control logic 1165 divides the encryption key according to a defined “column address bit unit” (S120). For example, a competent column address bit unit “m” may be obtained using the equation: m=log₂ M, where “M” is a given data page size. Thus, in the example of FIG. 4, since M is assumed to be 8192 (2¹³), then m may be assumed to be 13. That is, in an exemplary method step S120, the key control logic 1165 may divide a received encryption key by a column address bit unit of 13. Referring more generically to FIG. 7, a given “n-bit” encryption key may be divided according to a given “m-bit” column address unit. Thus, in FIG. 7, the n-bit encryption key may be divided as [a1 to a13], [a14 to a26], [a27 to a39], . . . , down to [a(n−12) to an].

Next, the key control logic 1165 may be used to determine a particular column address for a word line WLi, wherein “i” is assumed to range between 0 and “t”. In certain embodiments of the inventive concept, “i” may vary according to the size of the encryption key. That is, “t” may be obtained from the equation: t=[(n÷m)−1], where “n” is the size of the encryption key, and “m” is the column address bit unit. Applying these principles to the working example yields: t=1 when n=26, and t=63 when n=832. Hereafter, it is assumed that the encryption key has a size (“n”) of 832.

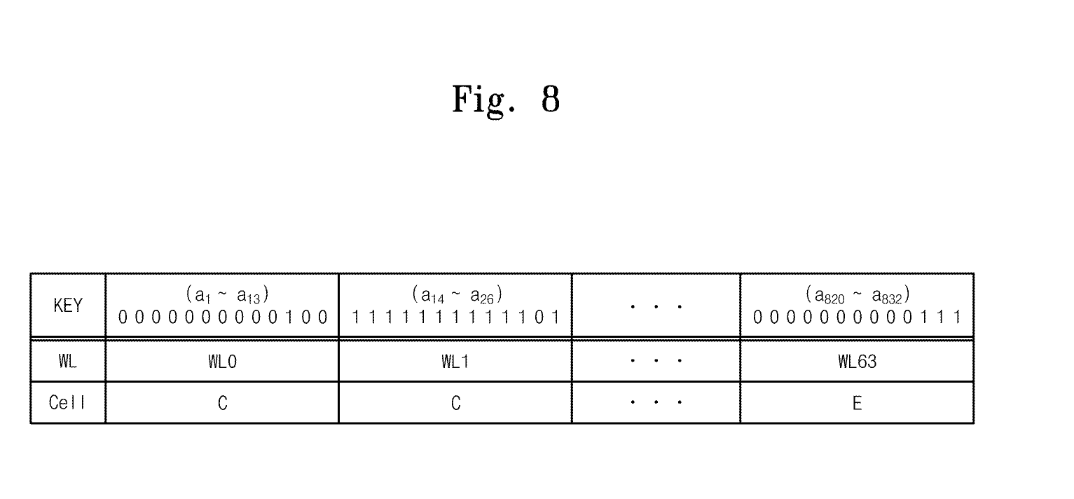

Referring now to FIG. 8, a column address corresponding to WL0 may be [a1 to a13]: [00000 00000 100]. A column address corresponding to WL0 may be [a14 to a26]: [11111 11111 101], and a column address corresponding to WL0 may be [a820 to a832]: [00000 00000 111].

Returning to FIG. 4, the key control logic 1165 now programs a selected memory cell (hereinafter, referred to as the “key cell”) corresponding to the determined column address WLi (S140). Referring again to FIG. 8, an encryption key [a1 to a13] will correspond to a column address [00000 00000 100], and the key control logic 1165 may thus program a key cell C. In this case, the remaining cells will be program inhibited. That is, a selected key cell C among memory cells connected to WL0 may be programmed to a data value of ‘0’, while the remaining memory cells connected to WL0 maintain an erase state or a stored data value of ‘1’.

Likewise, an encryption key [a14 to a26] may correspond to a column address [11111 11111 101], and the key control logic 1165 may program a key cell D. An encryption key [a820 to a832] may correspond to a column address [00000 00000 111], and the key control logic 1165 may program a key cell E.

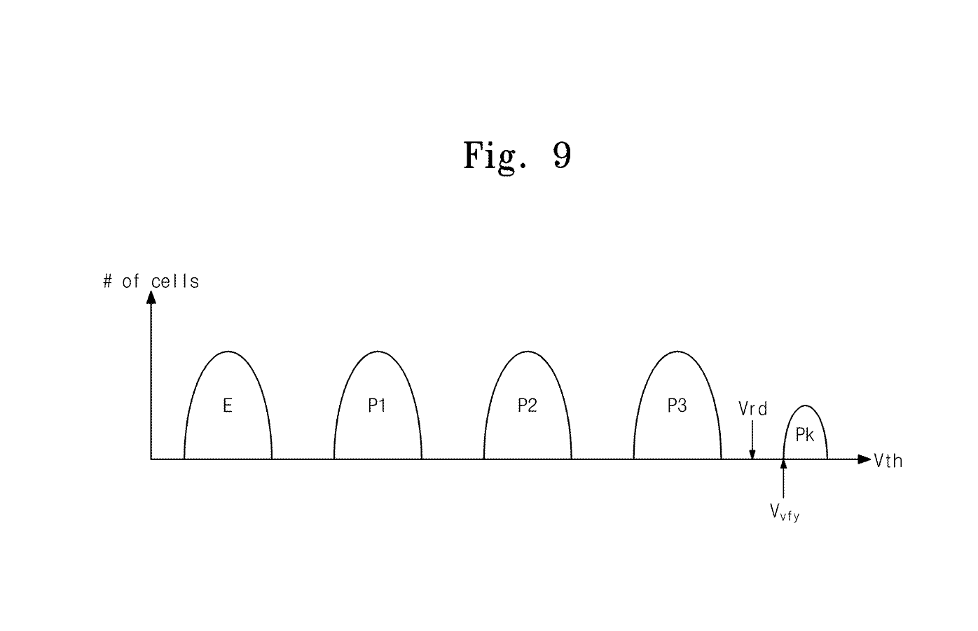

FIG. 9 is a diagram illustrating one possible method of programming a key cell corresponding to a determined column address. In FIG. 9, the horizontal axis indicates threshold voltage of a memory cell, and the vertical axis indicates the number of memory cells. FIG. 9 illustrates a case wherein 2-bit data is stored per memory cell. However, the inventive concept is not limited thereto. For example, the inventive concept is applicable to such a case that one bit of data or three or more bits of data are stored at a memory cell.

Referring to FIG. 9, a key cell may be assumed to have a “key cell threshold voltage distribution” of Pk, while other cells have a threshold voltage distribution corresponding to one of the data states E, P1, P2, and P3. Pk may indicate a threshold voltage distribution of a key cell C, D, or E corresponding to a determined column address (S140) as per the description above with reference to FIGS. 4 and 8.

As can be seen from FIG. 9, the key cell threshold voltage distribution Pk is greater than an uppermost threshold voltage distribution (e.g., P3) for normally stored data. The key control logic 1165 may be used to program a key cell connected with each word line to the key cell threshold voltage distribution, Pk. As illustrated in FIG. 9, a competent verification voltage (Vvfy) may be selected to verify the programing of a key cell to the key cell threshold voltage distribution.

Thereafter, the key control logic 1165 may detect a column address of a key cell (e.g., a memory cell C) by applying a corresponding read voltage (Vrd) to a selected word line (e.g., WL0). During a read operation performed with the read voltage Vrd applied to a selected word line, the key cell (e.g., the memory cell C) will be read as data ‘0’, while the remaining cells will be read as data ‘1’.

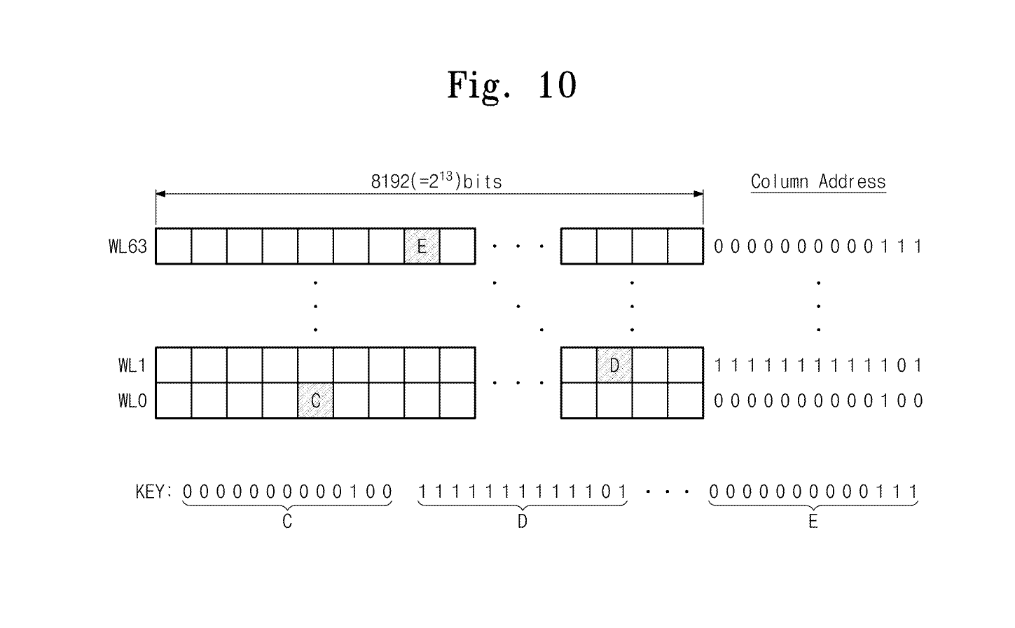

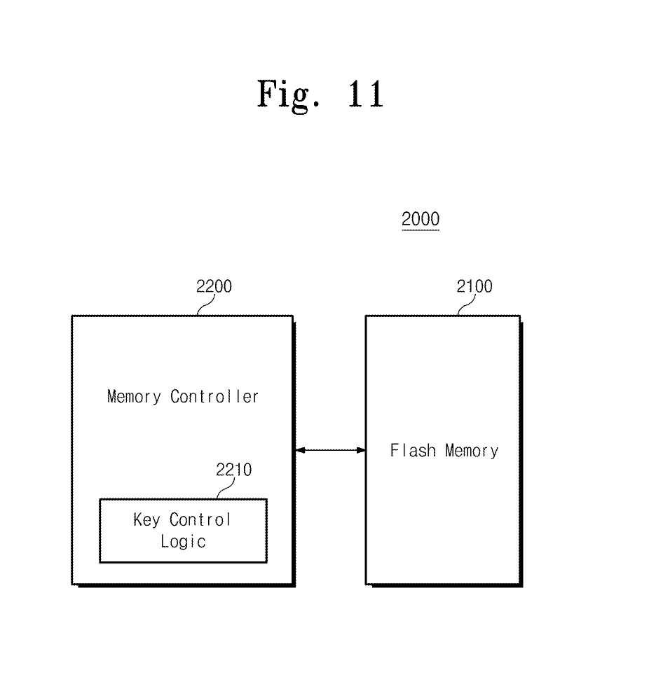

FIG. 10 is a conceptual diagram further illustrating one possible method of reading an encryption key stored in a memory cell array that is coincidently used to store user data, for example, . If a read voltage Vrd (refer to FIG. 9) is applied to word lines WL0 to WL63, key cells (e.g., memory cells C, D, and E) may be detected. That is, with the read voltage Vrd being applied to a selected word line, a key cell may be read as data ‘0’, and the remaining cells may be read as data ‘1’. An encryption key may be obtained by combing a column address of a key cell read as data ‘0’.

Returning to FIG. 4 to summarize the foregoing, the key control logic 1165 may receive an encryption key via a data I/O circuit 1140 (S110), divide the encryption key by a column address bit unit (S120), determine a key cell corresponding to a column address for each word line using the encryption key divided by the column address bit unit (S130), and then program the key cell to a specific key cell threshold voltage distribution (S140).

The flash memory device 1100 according to an embodiment of the inventive concept need not include a separate storage space dedicated to the storing of the encryption key. Instead certain key cells may be programmed to a higher-than-normal threshold voltage in view of defined “normal data” threshold voltage distributions. Hence, embodiments of the inventive concept may be used to store an encryption key according to a column address for key cell(s), and/or row address key cell(s).

In conventional memory systems storing an encryption key in flash memory, a separate erase operation directed to memory cells storing the encryption key must be performed. Certain conventional methods may necessitate a separate memory space for storing an encryption key, and may perform an erase operation separately.

However, with an encryption key storing method according to embodiments of the inventive concept, an encryption key may be stored via an overwrite operation without performing an erase operation. Since an address of a key cell is used, a separate memory space may not be needed. Also, with the inventive concept, although a flash memory device is lost, data may be protected safely. The reason may be that an encryption key is naturally lost by charge loss as a time elapses.

Since data is stored at a key cell, the flash memory device 1100 according to an embodiment of the inventive concept may correct an error generated from the key cell using ECC. The flash memory device 1100 according to an embodiment of the inventive concept may apply a simple ECC such as a repetition code with respect to an error correction operation associated with an encryption key storing operation.

FIG. 11 is a general block diagram illustrating a flash memory system that may incorporate an embodiment of the inventive concept. Referring to FIG. 11, a flash memory system 2000 comprises a flash memory 2100 and a memory controller 2200. The memory controller 2200 includes key control logic 2210.

The key control logic 2210 may receive an encryption key generated in the memory controller 2200, dividing the encryption key by a column address bit unit, deciding a key cell corresponding to a column address of each word line using an encryption key divided by the column address bit unit, and programming the key cell at the flash memory 2100 to have a specific threshold voltage distribution. In the flash memory system 2000, the flash memory 2100 may not include a separate memory space for storing an encryption key, and may program a key cell to have a threshold voltage higher than threshold voltages of the remaining cells.

A memory system according to an embodiment of the inventive concept may be applied or provided to various products. The memory system according to an embodiment of the inventive concept may be implemented by electronic devices such as a personal computer, a digital camera, a camcorder, a cellular phone, an MP3 player, a PMP, a PSP, a PDA, and the like as well as storage devices such as a memory card, an USB memory, a solid state drive (hereinafter, referred to as SSD), and the like.

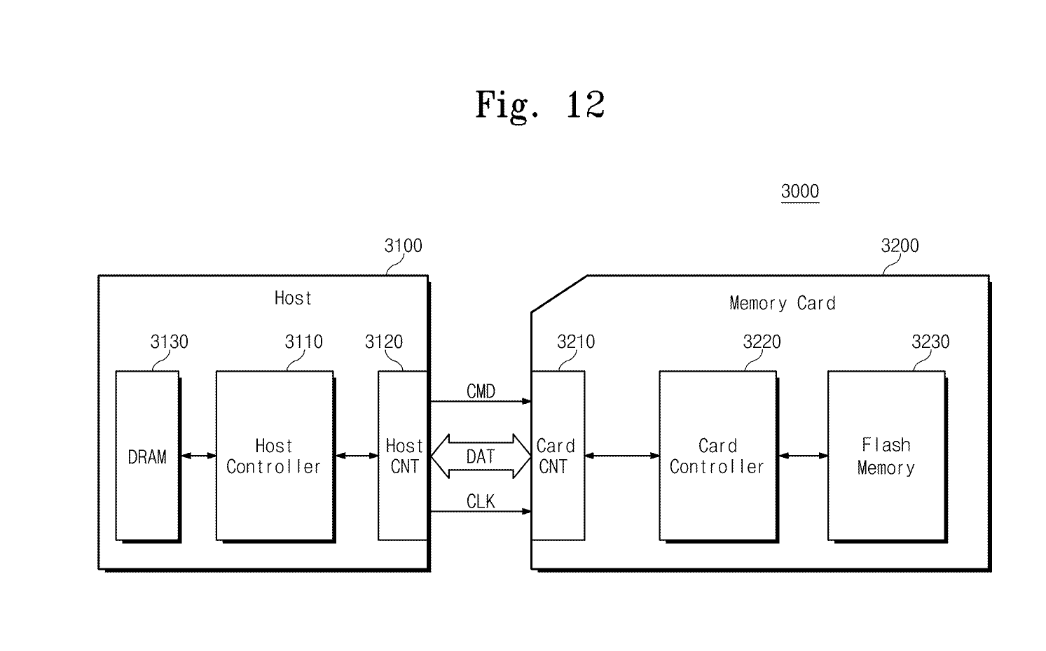

FIG. 12 is a block diagram illustrating a memory card system that may incorporate a memory system according to an embodiment of the inventive concept is applied. A memory card system 3000 may include a host 3100 and a memory card 3200. The host 3100 may include a host controller 3110, a host connection unit 3120, and a DRAM 3130.

The host 3100 may write data at the memory card 3200 and read data from the memory card 3200. The host controller 3110 may send a command (e.g., a write command), a clock signal CLK generated from a clock generator (not shown) in the host 3100, and data to the memory card 3200 via the host connection unit 3120. The DRAM 3130 may be a main memory of the host 3100.

The memory card 3200 may include a card connection unit 3210, a card controller 3220, and a flash memory 3230. The card controller 3220 may store data at the flash memory 3230 in response to a command input via the card connection unit 3210. The data may be stored in synchronization with a clock signal generated from a clock generator (not shown) in the card controller 3220. The flash memory 3230 may store data transferred from the host 3100. For example, in a case where the host 3100 is a digital camera, the memory card 3200 may store image data.

In the memory card system 3000, the card controller 3220 or the flash memory 3230 may be configured to include key control logic (refer to FIG. 2 or FIG. 11). In the memory card system 3000, the flash memory 3230 may not include a separate memory space for storing an encryption key, and may protect data safely by programming a key cell to have a threshold voltage higher than threshold voltages of the remaining cells.

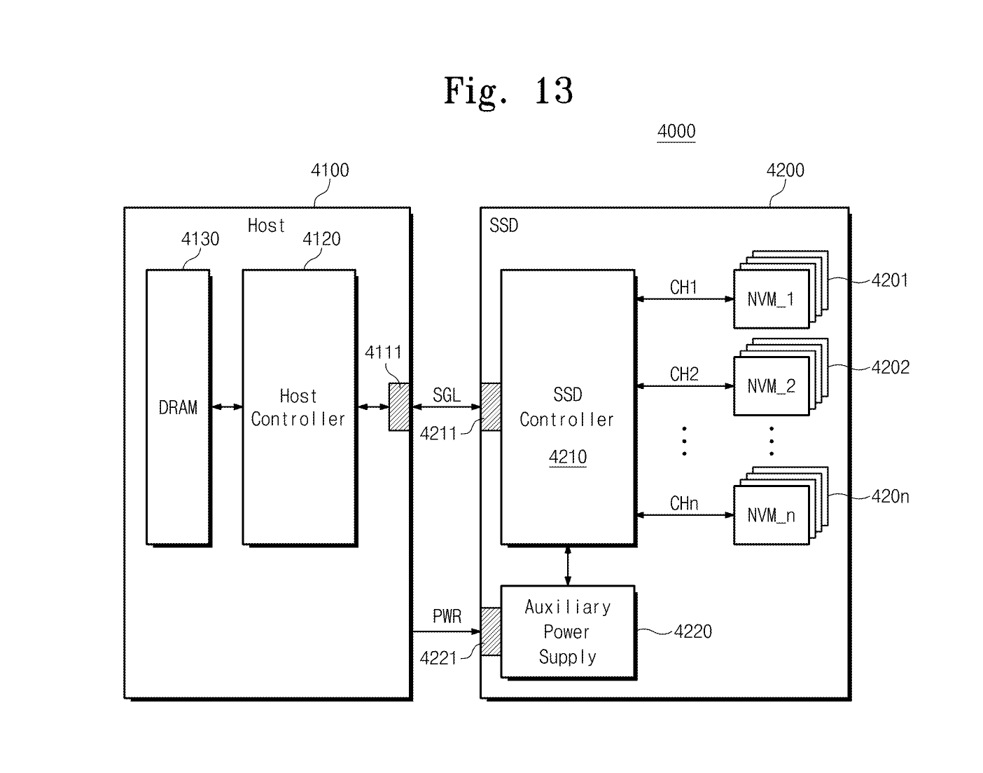

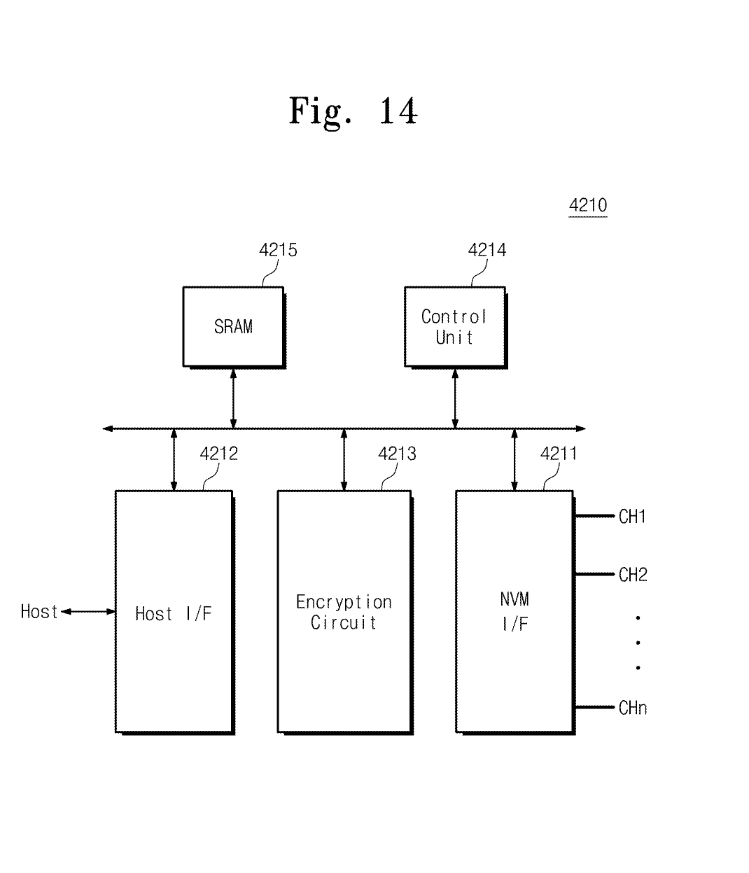

FIG. 13 is a block diagram illustrating a solid state drive system that may incorporate a memory system according to the inventive concept is applied. Referring to FIG. 13, a solid state drive (SSD) system 4000 may include a host 4100 and an SSD 4200. The host 4100 may include a host interface 4111, a host controller 4120, and a DRAM 4130.

The host 4100 may write data in the SSD 4200 or read data from the SSD 4100. The host controller 4120 may transfer signals SGL such as a command, an address, a control signal, and the like to the SSD 4200 via the host interface 4111. The DRAM 4130 may be a main memory of the host 4100.

The SSD 4200 may exchange signals SGL with the host 4100 via the host interface 4211, and may be supplied with a power via a power connector 4221. The SSD 4200 may include a plurality of nonvolatile memories 4201 to 420n, an SSD controller 4210, and an auxiliary power supply 4220. Herein, the nonvolatile memories 4201 to 420n may be implemented by not only a NAND flash memory but also a nonvolatile memory such as PRAM, MRAM, ReRAM, or the like.

The plurality of nonvolatile memories 4201 to 420n may be used as a storage medium of the SSD 4200. The plurality of nonvolatile memories 4201 to 420n may be connected with the SSD controller 4210 via a plurality of channels CH1 to CHn. One channel may be connected with one or more nonvolatile memories. Nonvolatile memories connected with one channel may be connected with the same data bus.

The SSD controller 4210 may exchange signals SGL with the host 4100 via the host interface 4211. Herein, the signals SGL may include a command, an address, data, and the like. The SSD controller 4210 may be configured to write or read out data to or from a corresponding nonvolatile memory according to a command of the host 4100. The SSD controller 4210 will be more fully described with reference to FIG. 14.

The auxiliary power supply 4220 may be connected with the host 4100 via the power connector 4221. The auxiliary power supply 4220 may be charged by a power PWR from the host 4100. The auxiliary power supply 4220 may be placed inside or outside the SSD 4200. For example, the auxiliary power supply 4220 may be put on a main board to supply an auxiliary power to the SSD 4200.

FIG. 14 is a block diagram further illustrating the SSD controller of FIG. 13. Referring to FIG. 14, an SSD controller 4210 may include an NVM interface 4211, a host interface 4212, an encryption circuit 4213, a control unit 4214, and an SRAM 4215.

The NVM interface 4211 may scatter data transferred from a main memory of a host 4100 to channels CH1 to CHn, respectively. The NVM interface 4211 may transfer data read from nonvolatile memories 4201 to 420n to the host 4100 via the host interface 4212.

The host interface 4212 may provide an interface with an SSD 4200 according to the protocol of the host 4100. The host interface 4212 may communicate with the host 4100 using USB (Universal Serial Bus), SCSI (Small Computer System Interface), PCI express, ATA, PATA (Parallel ATA), SATA (Serial ATA), SAS (Serial Attached SCSI), or the like. The host interface 4212 may also perform a disk emulation function which enables the host 4100 to recognize the SSD 4200 as a hard disk drive (HDD).

The encryption circuit 4213 may encrypt data using a key provided from a key generator included in the SSD controller 4210 or each of nonvolatile memories 4201 to 420n. The control unit 4214 may analyze and process signals input from the host 4100. The control unit 4214 may control the host 4100 or the nonvolatile memories 4201 to 420n through the host interface 4212 or the NVM interface 4211. The control unit 4214 may control the nonvolatile memories 4201 to 420n according to firmware to drive the SSD 4200.

The SRAM 4215 may be used to drive software which efficiently manages the nonvolatile memories 4201 to 420n. The SRAM 4215 may store metadata input from a main memory of the host 4100 or cache data. At a sudden power-off operation, metadata or cache data stored in the SRAM 4215 may be stored in the nonvolatile memories 4201 to 420n using an auxiliary power supply 4220.

In the SSD system 4000, the SSD controller 4210 or the nonvolatile memories 4201 to 420n may be configured to include key control logic (refer to FIG. 2 or FIG. 11). In the SSD system 4000, the nonvolatile memories 4201 to 420n may not include a separate memory space for storing an encryption key, and may protect data safely by programming a key cell to have a threshold voltage higher than threshold voltages of the remaining cells.

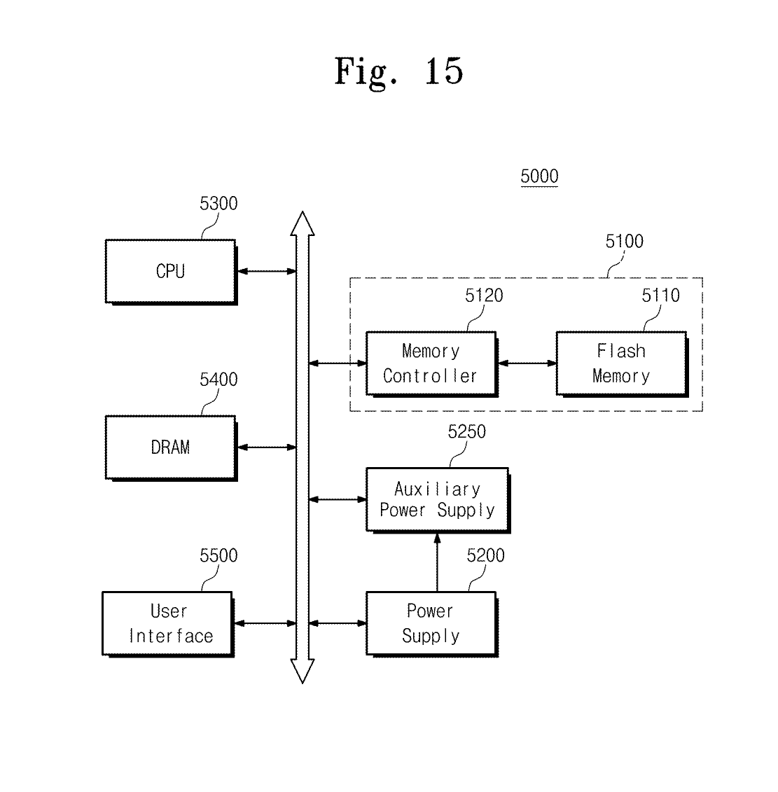

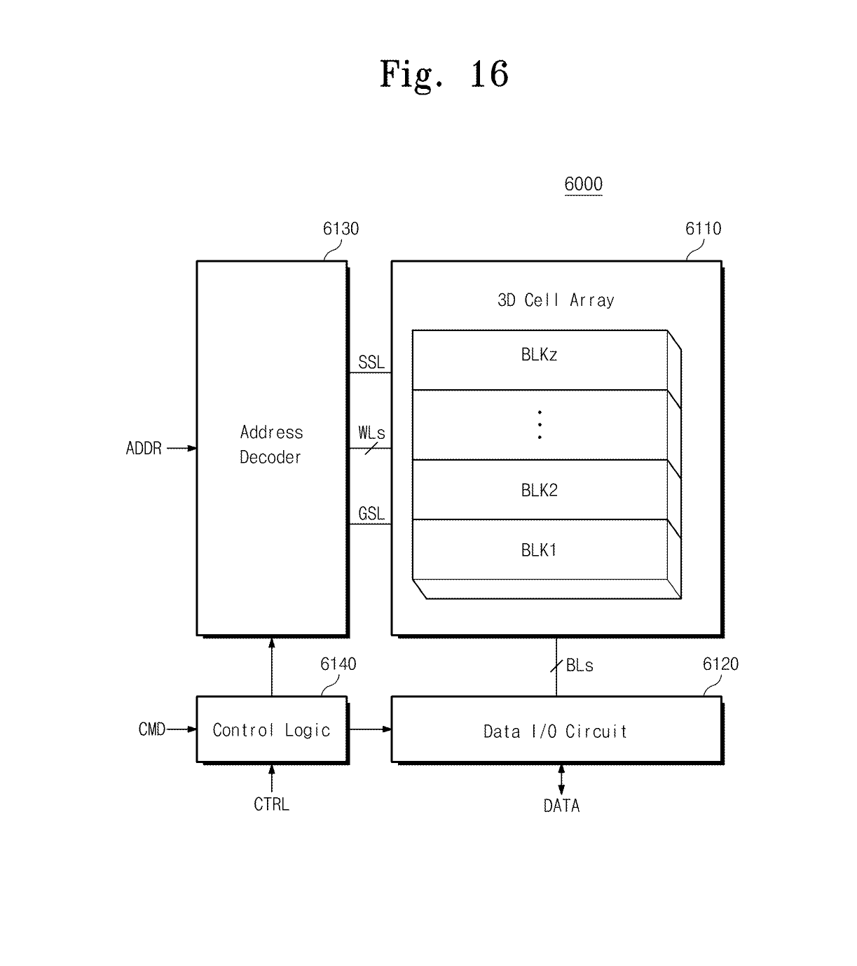

FIG. 15 is a block diagram illustrating an electronic device that may incorporate a flash memory system according to an embodiment of the inventive concept. Herein, an electronic device 5000 may be a personal computer or a handheld electronic device such as a notebook computer, a cellular phone, a PDA, a camera, or the like.

Referring to FIG. 15, the electronic device 5000 may include a memory system 5100, a power supply device 5200, an auxiliary power supply 5250, a CPU 5300, a DRAM 5400, and a user interface 5500. The memory system 5100 may include a flash memory 5110 and a memory controller 5120. The memory system 5100 can be built in the electronic device 5000.

In the electronic device 5000, the memory controller 5120 or the flash memory 5110 may be configured to include key control logic (refer to FIG. 2 or FIG. 11). In the electronic device 5000, the flash memory 5110 may not include a separate memory space for storing an encryption key, and may protect data safely by programming a key cell to have a threshold voltage higher than threshold voltages of the remaining cells.

A memory system according to an embodiment of the inventive concept is applicable to a flash memory having a three-dimensional structure as well as a flash memory having a two-dimensional structure.

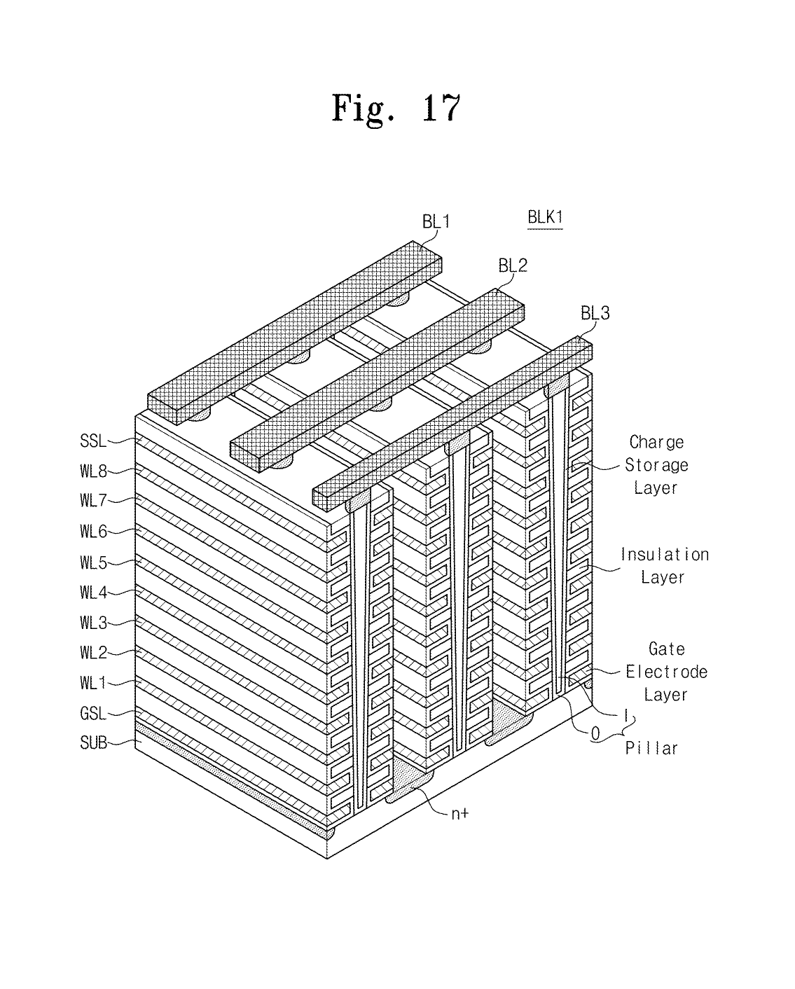

FIG. 16 is a block diagram illustrating a flash memory having a three dimensional (3D) memory cell array according to an embodiment of the inventive concept. Referring to FIG. 16, a flash memory 6000 may include a three-dimensional (3D) cell array 6110, a data input/output (I/O) circuit 6120, an address decoder 6130, and control logic 6140.

The 3D cell array 6110 may include a plurality of memory blocks BLK1 to BLKz, each of which is formed to have a three-dimensional structure (or, a vertical structure). In a memory block having a two-dimensional (horizontal) structure, memory cells may be formed in a direction parallel with a substrate. In a memory block having a three-dimensional structure, memory cells may be formed in a direction perpendicular to the substrate. Each of the memory blocks BLK1 to BLKz may be an erase unit of the flash memory 6000.

The data I/O circuit 6120 may be connected with the 3D cell array 6110 via a plurality of bit lines. The data input/output circuit 6120 may receive data from an external device or output data read from the 3D cell array 6110 to the external device. The address decoder 6130 may be connected with the 3D cell array 6110 via a plurality of word lines and selection lines GSL and SSL. The address decoder 6130 may select the word lines in response to an address ADDR.

The control logic 6140 may control programming, erasing, reading, etc. of the flash memory 6000. For example, at programming, the control logic 6140 may control the address decoder 6130 and the data I/O circuit 6120 such that a program voltage is supplied to a selected word line and data is programmed.

FIG. 17 is a perspective view further illustrating one possible implementation for the 3D memory cell array (e.g., a memory block) of FIG. 16. Referring to FIG. 17, a memory block BLK1 may be formed in a direction perpendicular to a substrate SUB. An n+ doping region may be formed at the substrate SUB. A gate electrode layer and an insulation layer may be deposited on the substrate SUB in turn. A charge storage layer may be formed between the gate electrode layer and the insulation layer.

If the gate electrode layer and the insulation layer are patterned in a vertical direction, a V-shaped pillar may be formed. The pillar may be connected with the substrate SUB via the gate electrode layer and the insulation layer. An outer portion O of the pillar may be formed of a channel semiconductor, and an inner portion I thereof may be formed of an insulation material such as silicon oxide.

The gate electrode layer of the memory block BLK1 may be connected with a ground selection line GSL, a plurality of word lines WL1 to WL8, and a string selection line SSL. The pillars of the memory block BLK1 may be connected with a plurality of bit lines BL1 to BL3. In FIG. 17, there is illustrated the case that one memory block BLK1 has two selection lines SSL and GSL, eight word lines WL1 to WL8, and three bit lines BL1 to BL3. However, the inventive concept is not limited thereto.

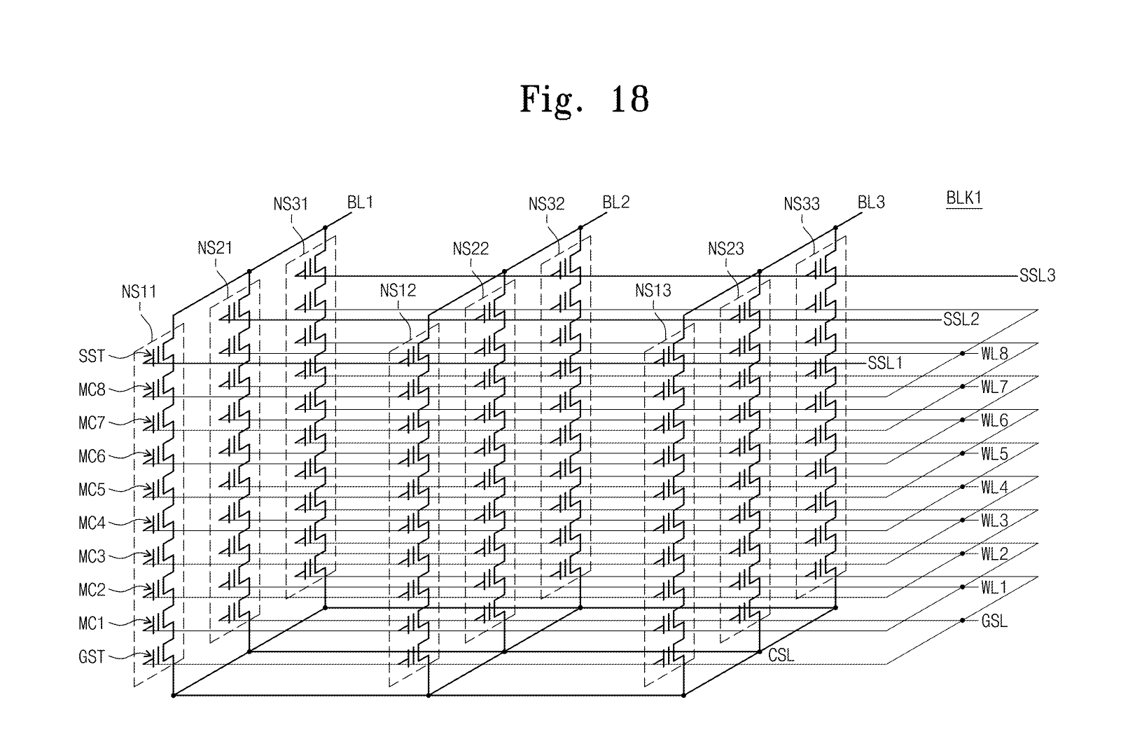

FIG. 18 is an equivalent circuit for the memory block of FIG. 17. Referring to FIG. 18, NAND strings NS11 to NS33 may be connected between bit lines BL1 to BL3 and a common source line CSL. Each NAND string (e.g., NS11) may include a string selection transistor SST, a plurality of memory cells MC1 to MC8, and a ground selection transistor GST.

The string selection transistors SST may be connected with string selection lines SSL1 to SSL3. The memory cells MC1 to MC8 may be connected with corresponding word lines WL1 to WL8, respectively. The ground selection transistors GST may be connected with ground selection line GSL. A string selection transistor SST may be connected with a bit line and a ground selection transistor GST may be connected with a common source line CSL.

Word lines (e.g., WL1) having the same height may be connected in common, and the string selection lines SSL1 to SSL3 may be separated from one another. At programming of memory cells (constituting a page) connected with a first word line WL1 and included in NAND strings NS11, NS12, and NS13, there may be selected a first word line WL1 and a first string selection line SSL1.

While the inventive concept has been described with reference to exemplary embodiments, it will be apparent to those skilled in the art that various changes and modifications may be made without departing from the scope of the present invention. Therefore, it should be understood that the above embodiments are not limiting, but illustrative.

What is claimed is:

1. A flash memory device comprising:
a plurality of memory cells including a key cell, each respectively connected to a word line;
a data input/output (I/O) circuit configured to receive the encryption key; and
key control logic configured to control a program operation directed to the key cell, wherein the program operation uses a column address of the key cell as the encryption key.

2. The flash memory device of claim 1, wherein the key control logic is further configured during an encryption key program operation to program the key cell to a key cell threshold voltage distribution, while program inhibiting other memory cells among the plurality of memory cells.

3. The flash memory device of claim 2, wherein key cell threshold voltage distribution is higher than any threshold voltage distribution of the other memory cells.

4. The flash memory device of claim 2, wherein a program verify voltage associated with the key cell threshold voltage distribution is higher than program verify voltages for the other memory cells.

5. The flash memory device of claim 2, wherein a read voltage associated with the key cell threshold voltage is higher than the threshold voltage distributions of the other memory cells.

6. The flash memory device of claim 5, wherein the key control logic is further configured during a read operation directed to the key cell to apply the read voltage of the key cell.

7. The flash memory device of claim 5, wherein the key control logic and data I/O circuit are further configured to combine and output an encryption key including a data bit read from the key cell.

8. The flash memory device of claim 2, wherein the key control logic is further configured to divide an encryption key received via the data I/O circuit by a column address bit unit.

9. The flash memory device of claim 8, wherein the key control logic is further configured to program the key cell corresponding to a column address of the word line and program inhibits the other memory cells.

10. The flash memory device of claim 1, wherein the key cell stores data via an overwrite operation without an immediately preceding erase operation.

11. The flash memory device of claim 2, wherein the data I/O circuit receives the encryption key together with encrypted data from a memory controller.

12. An encryption key storing method, comprising:
receiving an encryption key via a data input/output (I/O) circuit;
dividing the encryption key by a column address bit unit;
determining a key cell corresponding to a column address for each one of a plurality of word lines using a value equal to a size of the encryption key divided by the column address bit unit; and then,
programming the key cell according to a key cell threshold voltage distribution.

13. The encryption key storing method of claim 12, wherein the key cell connected with each one of the plurality of word lines is programmed while other memory cells are program inhibited.

14. A method of operating a flash memory storing an encryption key, the flash memory including a flash memory cell array having a plurality of multi-level flash memory cells, the method comprising:
generating encrypted data using the encryption key and storing the encrypted data in the flash memory cell array according to one of: an erase data state (E) indicated by an erased threshold voltage distribution (EThVD), a first programmed data state (P1) indicated by a first programmed threshold voltage distribution (P1ThVD) higher than the EThVD, a second programmed data state (P2) indicated by a second programmed threshold voltage distribution (P2ThVD) higher than the P1ThVD, and a third programmed data state (P3) indicated by a third programmed threshold voltage distribution (P3ThVD) higher than the P2ThVD;
determining key cells among the plurality of flash memory cells; and
during a program operation, programming each one of the key cells according to a key cell threshold voltage distribution (KCThVD) higher than the P3ThVD.

15. The method of claim 14, wherein determining the key cells comprises:
receiving the encryption key via a data input/output (I/O) circuit;
dividing the encryption key according to a column address bit unit to obtain a key value; and
using the key value to determine an address for each one of the key cells.

16. The method of claim 14, further comprising:
verifying the programming of each one of the key cells using a verify voltage higher than the P3ThVD.

17. The method of claim 14, further comprising:
reading a key cell during a read operation performed after the program operation using a read voltage higher than the P3ThVD.

18. The method of claim 14, wherein the encryption key and encrypted data are passed together from a memory controller to an encryption circuit during the program operation.

19. The method of claim 14, wherein the programming of each one of the key cells according to the KCThVD is performed by a direct overwrite operation without an immediately preceding erase operation.
